(19) United States
(12) Patent Application Publication
(10) Pub. No.: US 2007/0259670 A1
(43) Pub. Date: Nov. 8, 2007

(54) MOBILE WIFI NETWORK MONITOR

(76) Inventor: Ketul Sakhpara, Plano, TX (US)

Correspondence Address: CONLEY ROSE, P.C., 5601 GRANITE PARKWAY, SUITE 750, PLANO, TX, 75024, US

(21) Appl. No.: 11/381,846

(22) Filed: May 5, 2006

(51) Int. Cl. H04Q 7/20

(52) U.S. Cl. 455/452.2

(57) ABSTRACT

A system for determining bandwidth in a hotspot is provided. The system includes a handset having an analyzer client operable to measure a bandwidth in the hotspot and a time and a location data related to the bandwidth measurement and an analyzer server operable to maintain the bandwidth, time, and location data received from the advisor client.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to wireless networking. More specifically, but not by way of limitation, a method and system are described that provide for the automated collection and analysis of wireless network bandwidth data.

### BACKGROUND OF THE INVENTION

In wireless networking, a client device can communicate wirelessly with an access point or a similar communication node. The access point might connect with the Internet, perhaps through one or more intermediate nodes such as an Internet router. The access point typically sends data to and receives data from the client device via electromagnetic waves transmitted according to one of the IEEE 802.11x standards or similar protocols. An area over which such a transmission from a single access point extends can be referred to as a hotspot. In common parlance, any location in which a client device can connect wirelessly to the Internet might be referred to as a hotspot, but in such terminology a hotspot might be a large area that includes a large number of access points. As used herein, the term “hotspot” will refer to the area covered by a single access point. A location in which the ranges of two or more access points overlap would also be considered a hotspot under the current usage.

The client device might be a laptop computer, a handheld computer, or a mobile telephone, personal digital assistant, or similar device that is capable of connecting wirelessly to the Internet using 802.x set of wireless protocols. Any mobile device that can wirelessly connect to the Internet using 802.x, or after developed wireless protocols, will be referred to herein as a handset. Some handsets might also be capable of placing and receiving telephone calls via a wireless connection with a cellular telephone network or a similar wireless telecommunications network. Such a handset can be referred to as a dual-mode handset.

A dual-mode handset that is connected to the Internet through a WiFi hotspot can be used to perform several different functions, such as browsing the World Wide Web, sending and receiving email, engaging in Voice over Internet Protocol (VoIP) telephone calls, or receiving streaming audio or video webcasts. Some of these activities, such as browsing the Web or sending email, require a connection to the Internet with a relatively small bandwidth, while others, such as placing VoIP calls or receiving streaming video, require a relatively large bandwidth. Thus, the functions that can be performed on a handset in a given hotspot at a given time might depend on the bandwidth of the Internet connection in that hotspot at that time. A hotspot with the bandwidth to allow web browsing may not necessarily be capable of handling VoIP calls, for example.

### SUMMARY OF THE INVENTION

In one embodiment, a system for determining bandwidth in a hotspot is provided. The system includes a handset having an analyzer client operable to measure bandwidth in the hotspot and a time and a location data related to the bandwidth measurement and an analyzer server operable to maintain the bandwidth, time, and location data received from the advisor client.

In another embodiment, a method for determining a bandwidth in a location is provided. The method includes using a dual-mode handset to determine the bandwidth of a first access point at a first time, using the handset to determine the bandwidth of the first access point at a second time, and using the bandwidth information for the first and second times to estimate the bandwidth at the first access point.

In another embodiment, a method for identifying locations for placement of a hotspot is provided. The method includes collecting a plurality of bandwidth measurements in a plurality of locations at a plurality of times, calculating an average bandwidth for at least some of the plurality of locations and for at least some of the plurality of times, and designating a particular location where the average bandwidth is below a threshold as a candidate for the placement of the hotspot.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a system for collecting and analyzing wireless network bandwidth data according to an embodiment of the present disclosure.

FIG. 2 illustrates a method for collecting and analyzing wireless network bandwidth data according to an embodiment of the present disclosure.

FIG. 3 illustrates a method for designating a location as a candidate for a placement for a hotspot according to an embodiment of the present disclosure.

FIG. 4 illustrates a block diagram of a handset operable for some of the various embodiments of the present disclosure.

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

A hotspot operator, such as a telecommunications company, typically has direct access to information regarding the bandwidth available in the hotspots that it operates. However, bandwidth information for hotspots managed by others may not be readily available to such a hotspot operator. In embodiments of the present disclosure, a method and system are described that provide for the automated collection and analysis of WiFi network bandwidth data. An analyzer client oh a handset is capable of collecting bandwidth measurements in multiple hotspots at multiple times. The measurements are uploaded to an analyzer server, which is capable of collecting data from multiple handsets. The analyzer server analyzes the data received from the handsets and determines an average bandwidth available in the hotspots at various times of the day. This information might be used to determine whether sufficient bandwidth exists to execute a particular application, to determine whether the addition of a new hotspot is warranted, or for other purposes.

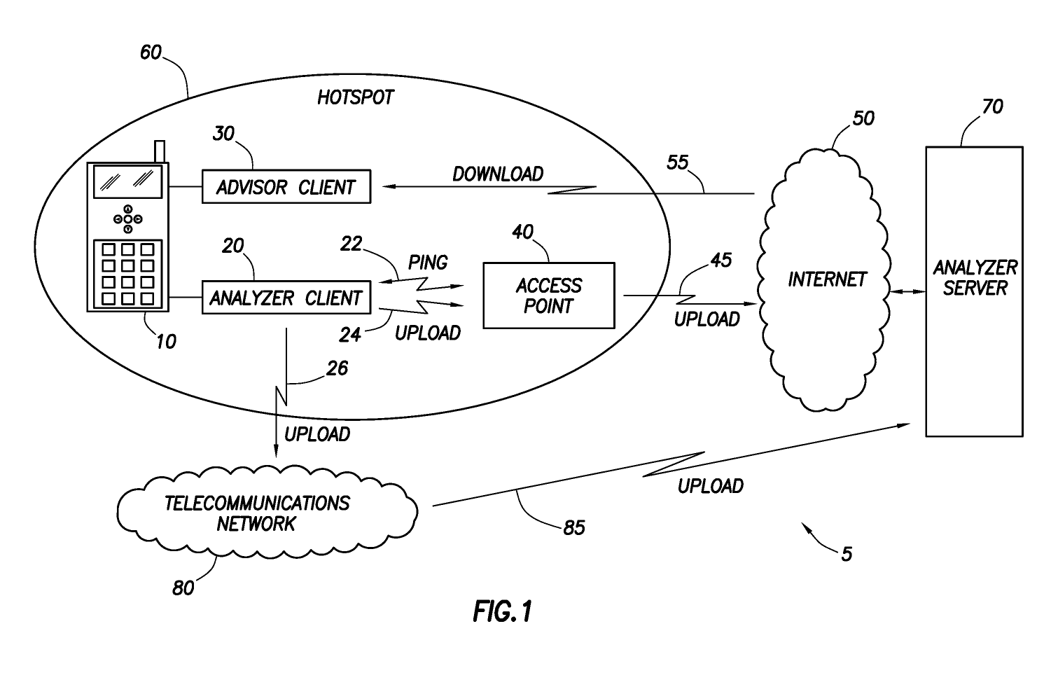

FIG. 1 illustrates an embodiment of a system 5 for collecting and analyzing wireless network bandwidth data. A handset 10 includes an analyzer client 20 and an advisor client 30. While the analyzer client 20 and the advisor client 30 are depicted outside the handset 10 for the sake of clarity in the drawing, it should be understood that these components may be contained within or otherwise integrated with the handset 10. An access point 40 or similar device that allows mobile devices to connect to the Internet 50 transmits and receives data wirelessly within a small region, thus creating a hotspot 60. When the handset 10 is within the hotspot 60, the handset 10 can communicate wirelessly with the access point 40. The access point 40 might connect to the Internet 50 directly or through one or more intermediate nodes, not shown.

The analyzer client 20 is capable of determining the bandwidth currently available in the hotspot 60. The bandwidth determination might be carried out by means of a “ping” 22 or a similar bandwidth measurement technique. The pinging 22 might consist of the analyzer client 20 sending a data packet of a known size to the access point 40. The packet might pass from the access point 40 through the Internet 50, such as to a known or intended server, which may return a signal or the packet to the access point 40 and thence to the analyzer client 20.

The analyzer client 20 can measure the length of time needed for the packet to return to the analyzer client 20 and can calculate the bandwidth available in the hotspot 60 based on the packet size and the round trip packet transmission time. In a typical bandwidth test, several hundred data packets might be transmitted over a period of several seconds and the bandwidth might be calculated from the average transmission time of the packets.

After obtaining a bandwidth measurement, the analyzer client 20 can store the measurement along with the time and location at which the measurement was made. Location data might be obtained from a global positioning system or other location determination component in the handset 10. Since the analyzer client 20 may not necessarily learn an identity for a hotspot in which it is present, location data may be stored as a geographic location rather than as a hotspot identity.

The bandwidth measurement information might be stored in a dedicated memory component within the analyzer client 20 or within a shared memory area in the handset 10. Data from multiple measurements can be stored in this manner.

The available bandwidth measured in a hotspot can depend on the size of the data packets used to carry out the bandwidth measurement. That is, the bandwidth measured in a particular hotspot at a particular time, as determined by the transmission time for small-sized data packets, might be different from the bandwidth measured in the same hotspot at the same time when large-sized data packets are transmitted. To account for this difference, the analyzer client 20 might perform one bandwidth test using small packets and another bandwidth test using large packets. A separate bandwidth could be calculated for each test and the two bandwidths could be stored separately.

As an example, the analyzer client 20 might transmit a series of 1-kilobit data packets to the access point 40 to measure the small-packet bandwidth and a series of 100-kilobit data packets to measure the large-packet bandwidth A first bandwidth might be calculated using the 1-kilobit data and a second bandwidth might be calculated using the 100-kilobit data. The two bandwidth calculations might comprise a single bandwidth test for a particular hotspot at a particular time.

The bandwidth available in a hotspot can vary over time. To obtain an accurate representation of a hotspot's bandwidth, bandwidth tests might need to be conducted in the hotspot on several different occasions. In an embodiment, the analyzer client 20 performs bandwidth measurements at regular intervals throughout the time it is present in the hotspot 60. For example, the measurements might be made every fifteen minutes, every hour, or at some other interval. The more measurements that are collected, the more accurate the representation of the bandwidth of the hotspot 60 can be. However, the collection of an excessive number of measurements can overload the memory capacity of the analyzer client 20 or the handset 10. The frequency at which bandwidth measurements are made can be selected so that an appropriate balance is achieved between accurate representation of the bandwidth and efficient use of resources. The measurements collected over time can be stored until they are uploaded to an analyzer server 70, as described below.

A user carrying the handset 10 might move into and out of numerous hotspots during the course of a day. In an embodiment, the analyzer client 20 can detect when the handset enters a hotspot and performs a bandwidth test whenever the handset 10 is brought into a hotspot. The bandwidth test conducted upon entry into a hotspot can override the periodic bandwidth measurements described above. That is, a bandwidth test might be done as soon as the handset 10 moves from one hotspot to another regardless of the frequency at which the analyzer client 20 is set to carry out bandwidth measurements.

For example, the analyzer client 20 might conduct a bandwidth test every fifteen minutes and might have conducted a test ten minutes prior to the handset 10 moving out of a first hotspot and into a second hotspot. Rather than retaining the fifteen-minute interval and performing another test five minutes after entering the second hotspot, the analyzer client 20 might perform a bandwidth test upon entering the second hotspot. If the handset 10 remains in the second hotspot, the fifteen-minute testing interval might resume. If the handset 10 moves to a third hotspot, another bandwidth test might be conducted upon entry into the third hotspot.

In this way, the analyzer client 20 might perform at least one bandwidth test in every hotspot that the handset 10 enters. The measurements collected in this manner are stored along with the time and location at which the measurements were made. If the handset 10 moves to an area outside the range of any access point, that is, if the handset 10 is no longer in a hotspot, the analyzer client 20 might automatically cease to attempt to obtain bandwidth measurements.

The bandwidth, time, and location information that the analyzer client 20 stores over an extended period of time is uploaded to the analyzer server 70. In an embodiment, the handset 10 is a dual-mode handset that can communicate with the analyzer server 70 through the Internet 50 or through a wireless telephone call. The analyzer client 20 can upload bandwidth data through either of these two paths. When sufficient bandwidth is available for an upload, the upload can occur via the access point 40. That is, during the course of conducting bandwidth tests, the analyzer client 20 might determine that the bandwidth available in a particular hotspot at a particular time is great enough that the data that has been stored since the previous upload can be uploaded to the analyzer server 70 without disruption to any applications on the handset 10 that might need to make use of that bandwidth. In this case, the analyzer client 20 uploads its bandwidth, time, and location data via path 24 to the access point 40. The access point 40 then uploads the data, via path 45, to the Internet 50 and thence to analyzer server 70.

Alternatively, the analyzer client 20 might upload its bandwidth, time, and location data via path 26 to a telecommunications network 80. The telecommunications network 80 then uploads the data, via path 85, to the analyzer server 70. Path 26 and path 85 may represent wireless data transmissions that follow a CDMA, GSM, EV-DO, or other well-known wireless telecommunications protocol. Uploading via the telecommunications network 80 might occur when sufficient bandwidth is not available to upload data via the access point 40. Alternatively, uploading via the telecommunications network 80 might occur at night when cellular network traffic tends to be relatively light.

In this way, the analyzer client 20 might upload its data to the analyzer server 70 at least once per day. Uploads via the access point 40 might occur when sufficient bandwidth is available and uploads via the telecommunications network 80 might occur at night. If sufficient bandwidth does not become available for an upload via the access point 40, all of the data stored by the analyzer client 20 might be uploaded at night via the telecommunications network 80. If one or more uploads occur via the access point 40, the nighttime upload via the telecommunications network 80 might include only the data that was stored since the last upload via the access point 40. Regardless of the upload path, the uploads can occur in the background from the handset user's perspective. No actions are required by the user to initiate or manage the uploads and no interference with the applications on the handset 10 occurs.

In an embodiment, a plurality of handsets similar to the handset 10 of FIG. 1 each contains an analysis component equivalent to the analyzer client 20. Each time such a handset enters a hotspot similar to the hotspot 60 of FIG. 1, the analysis component can perform a bandwidth test as described above. The analysis component can store a plurality of bandwidth measurements and upload the measurements to the analyzer server 70 as described above. In this way, a large number of bandwidth measurements can be collected in a large number of hotspots over an extended period of time.

In an embodiment, the analyzer server 70 receives bandwidth measurements and the associated time and location data from a plurality of handsets. The analyzer server 70 then aggregates the data to derive composite information, such as average available bandwidths, for multiple locations at various times of day. Average bandwidth data might apply to various sizes of geographical areas and various periods of time. For example, the analyzer server 70 might determine that the average available bandwidth for a particular one city block-sized area between 1:00 PM and 2:00 PM for small-sized data packets is 1 kilobit per second. The analyzer server 70 might use other sets of bandwidth data to determine that the average available bandwidth for a particular one square mile-sized area between 8:00 AM and 5:00 PM for large-sized data packets is 100 kilobit per second. Other sizes of areas and other periods of time could be used as appropriate.

The area sizes and time periods used by the analyzer server 70 might depend on the number of measurements available to the analyzer server 70. When only a small number of data points are available, a bandwidth average might need to apply to a large area and/or a long time. When a large number of measurements are available, a more finely grained analysis might be performed. Alternatively, an operator of the analyzer server 70 might specify the size of the areas and/or the periods of time over which bandwidth averages are to be determined. The analyzer server 70 might create maps or other reports of the average bandwidths over a plurality of locations and over a plurality of times.

The analyzer server 70 can download average bandwidth data to an advisor client 30 on the handset 10. The download might be initiated by the analyzer server 70 or the advisor client 30 might dynamically retrieve the average bandwidth data as needed, such as when an application is launched. The advisor client 30 can then inform a user of the handset 10 of the average bandwidth available at the current time at the user's current location. The advisor client 30 can also inform the user of the applications that are likely to function properly based on the average bandwidth information. For example, the user might attempt to perform an action, such as viewing a streaming video clip, that requires a large bandwidth. If the average bandwidth information received from the analyzer server 70 indicates that sufficient bandwidth is not likely to be available to perform the action, the advisor client 30 might inform the user of that fact before the action is attempted. This can prevent the user from starting an application that is not likely to successfully execute.

One method of determining the bandwidth available in a hotspot is to take a single, instantaneous bandwidth measurement. However, since the bandwidth available in a hotspot can vary over time, a single bandwidth measurement may not give an accurate representation of the bandwidth available over an extended time. A single measurement of a high bandwidth might prompt a user to launch an application that requires a high bandwidth and the application might fail if the bandwidth later decreases. The average bandwidth information provided by the advisor client 30 can give a more accurate depiction of the bandwidth likely to available in a hotspot over an extended time.

Another use for the average bandwidth information derived by the analyzer server 70 is in determining appropriate locations to install new hotspots. A map of the average bandwidths available over a wide geographical area might indicate that one or more portions of the area have no hotspots or have hotspots with inadequate bandwidth. A hotspot operator with access to this information might decide to create new hotspots in the areas with inadequate coverage.

A hotspot operator might also use this information to confirm the bandwidths that are available in the hotspots that it operates. The hotspot operator might be aware of a nominal bandwidth that should be available in a hotspot based on the hardware used to create the hotspot and on other parameters that might affect bandwidth. By measuring actual bandwidths and calculating average bandwidths as described herein, the analyzer server 70 can inform the hotspot operator whether a particular hotspot is operating as it was designed.

Another use for the average bandwidth information derived by the analyzer server 70 is in determining whether a particular handset application should be marketed in a particular area. A company that is marketing a new wireless networking application that requires a great deal of bandwidth might wish to know the areas that have sufficient bandwidth to allow the application to execute properly. The company may decide to market the product only in areas that have sufficient average bandwidth. Alternatively, the company may delay the introduction of the application into the marketplace until the number of hotspots with the bandwidth needed for the application to function properly is great enough for the marketing of the application to be economically feasible.

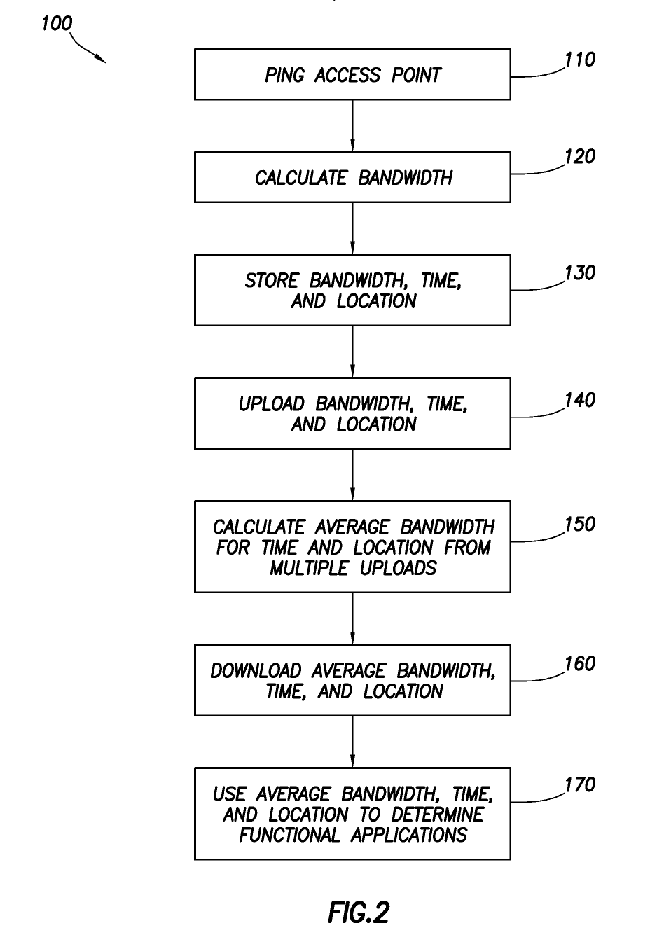

FIG. 2 illustrates a method 100 for collecting and analyzing wireless network bandwidth data. In box 110, an access point is pinged. In box 120, a bandwidth is calculated based on the data obtained from the ping. In other embodiments, methods other than pinging could be used to obtain a bandwidth measurement. In box 130, the calculated bandwidth is stored together with the time and location at which the ping occurred. The bandwidth, time, and location are uploaded in box 140. In box 150, an average bandwidth is calculated for a time and location based on a plurality of bandwidths uploaded for that time and location. In box 160, an average bandwidth and its associated time and location are downloaded. In box 170, the average bandwidth and associated time and location are used to determine whether an application is likely to function at a current time and location. In other embodiments, the average bandwidth information could be put to other uses. For example, this information could be used to suggest other applications or solutions for the user.

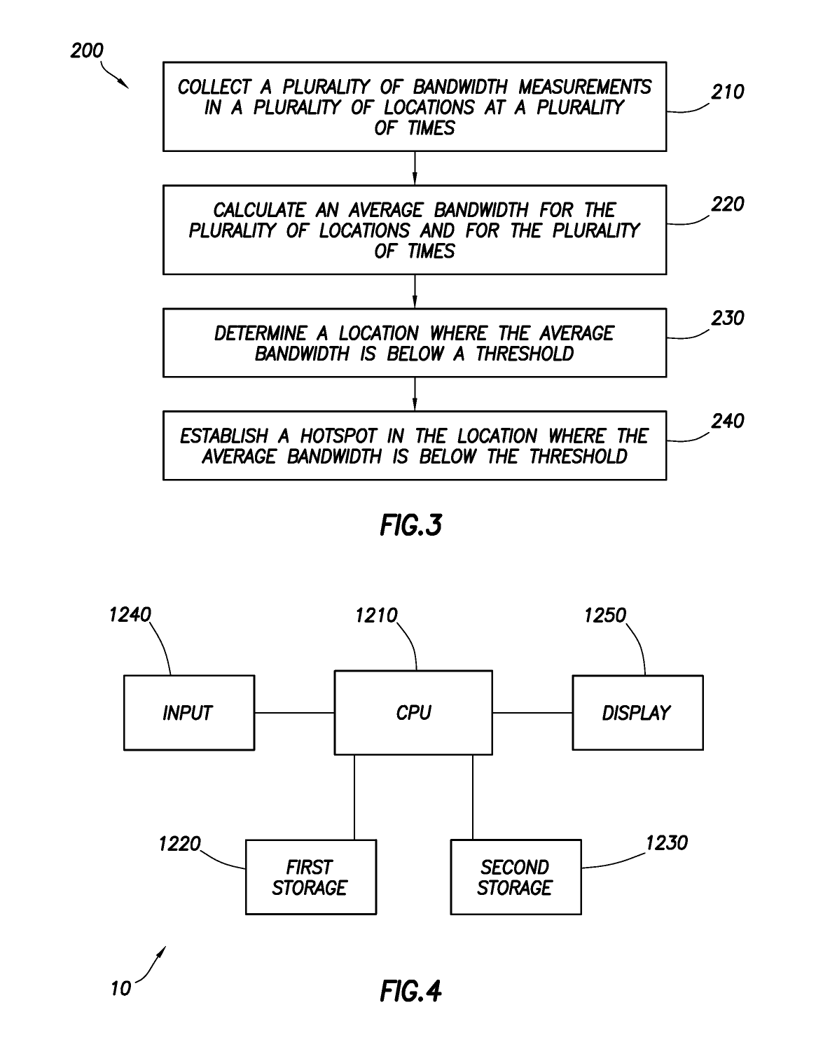

FIG. 3 illustrates a method 200 for discovering an appropriate placement for a hotspot. In box 210, a plurality of bandwidth measurements are collected in a plurality of locations at a plurality of times. In box 220, an average bandwidth is calculated for the plurality of locations at the plurality of times. In box 230, a location where the average bandwidth is below a threshold is determined. For example, it might be desired that an entire geographical region have an average available bandwidth of at least 100 kilobits per second and the average bandwidth calculations might reveal that a portion of the geographical region has an available bandwidth below this level. In box 240, a hot spot is established in the location where the average bandwidth is below the threshold. For example, a hotspot might be created in the portion of the geographical region where the average available bandwidth was less than 100 kilobits per second.

The system described above may be implemented on any handset 10 such as is well known to those skilled in the art. An exemplary handset 10 for implementing one or more embodiments disclosed herein is illustrated in FIG. 4. The handset 10 includes a processor 1210 (which may be referred to as a central processor unit or CPU) that is coupled to a first storage area 1220, a second storage area 1230, an input device 1240 such as a keypad, and an output device such as a display screen 1250.

The processor 1210 may be implemented as one or more CPU chips and may execute instructions, codes, computer programs, or scripts that it accesses from the first storage area 1220 or the second storage area 1230. The first storage area 1220 might be a non-volatile memory such as flash memory. The second storage area 1230 might be firmware or a similar type of memory.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for determining bandwidth in a hotspot comprising:
a handset having an analyzer client operable to measure bandwidth in the hotspot, the analyzer client further operable to determine a time and a location data related to the bandwidth measurement; and
an analyzer server operable to maintain the bandwidth, time, and location data received from the analyzer client.

2. The system of claim 1, wherein the analyzer server determines an average bandwidth for at least one hot spot and wherein the handset is a dual-mode handset.

3. The system of claim 1, wherein the analyzer client occasionally takes another bandwidth measurement at the location.

4. The system of claim 1, wherein a plurality of measurements of the bandwidth occur after entry of the handset into the hotspot.

5. The system of claim 1, wherein the determination of the bandwidth comprises determination of a first bandwidth for one or more data packets of a first size and determination of a second bandwidth for one or more data packets of a second size, the second size data packets larger than the first size data packets.

6. The system of claim 1, wherein bandwidth determinations are made by the handset in a plurality of hotspots.

7. The system of claim 6, wherein the handset uploads bandwidth data to the analyzer server via a wireless Internet connection when the bandwidth of the hotspot is at least about a certain size and wherein the uploads occur via a telecommunications connection when the bandwidth of the is less than about the certain size.

8. The system of claim 1, further comprising a plurality of handsets in a plurality of hotspots, each of the plurality of handsets operable to take bandwidth measurements, the analyzer server operable to receive the bandwidth measurements from the plurality of handsets and calculate an average bandwidth based on the bandwidth measurements made by the plurality of handsets in the plurality of hotspots.

9. The system of claim 8, wherein the analyzer server is operable to download the average bandwidth to an advisor client on the handset, the advisor client operable to promote determining whether the average bandwidth is sufficient to execute an application on the handset.

10. A method for determining a bandwidth in a location comprising:
using a handset to determine the bandwidth of a first access point at a first time;
using the handset to determine the bandwidth of the first access point at a second time; and
using the bandwidth information for the first and second times to estimate the bandwidth at the first access point.

11. The method of claim 10, wherein the handset pings the first access point to determine the bandwidth.

12. The method of claim 10, wherein the handset determines the bandwidth of the first access point at a plurality of times.

13. The method of claim 10, further comprising communicating bandwidth data from the handset to a server and storing the bandwidth data to the server.

14. The method of claim 13, further comprising, depending on the bandwidth of the first access point, uploading the bandwidth information to the server via one of a wireless Internet connection and a telecommunications connection.

15. The method of claim 10, further comprising a plurality of handsets in a plurality of locations determining the bandwidth of a plurality of access points including the first access point.

16. The method of claim 10, further comprising downloading the average bandwidth for a particular location from the analyzer server to an advisor client on the handset, the advisor client promoting the determination of whether the average bandwidth for the particular location is sufficient to execute an application on the handset in the particular location.

17. The method of claim 10, further comprising using the plurality of bandwidth information to calculate an average bandwidth for the first access point and to evaluate whether a geographical area requires additional bandwidth.

18. A method for identifying locations for placement of a hotspot comprising:
collecting a plurality of bandwidth measurements in a plurality of locations at a plurality of times;
calculating bandwidth estimates for at least some of the plurality of locations and for at least some of the plurality of times; and
designating a particular location where the average bandwidth is below a threshold as a candidate for the placement of the hotspot.

19. The method of claim 18, wherein at least some of the plurality of locations are hotspots operated by a plurality of hotspot operators.

20. The method of claim 18, wherein a plurality of mobile handset is used to take the plurality of bandwidth measurements in the plurality of locations at the plurality of times.
